(19) United States
(12) Patent Application Publication
(10) Pub. No.: US 2007/0127931 A1
(43) Pub. Date: Jun. 7, 2007

(54) Optical transceiver module

(75) Inventors: Hoon Kim, Suwon-si (KR); Sung-Kee Kim, Suwon-si (KR); Han-Lim Lee, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/607,701

(22) Filed: Dec. 1, 2006

(30) Foreign Application Priority Data
Dec. 2, 2005 (KR) 2005-117093

(51) Int. Cl. H04B 10/04; H04B 10/12

(52) U.S. Cl. 398/186

(57) ABSTRACT

Disclosed is an optical transceiver module for modulating a binary signal into an optical signal and outputting the optical signal. In one aspect, the optical transceiver module comprises a tap for dividing a binary signal into first and second binary signals, a laser source for frequency-modulating the first binary signal divided by the tap, and an intensity modulator for modulating the second binary signal divided by the tap and the frequency-modulated signal of the laser source into a phase-inverted optical signal.

### CLAIM OF PRIORITY

This application claims the benefit of the earlier filing date, under 35 U.S.C. 119(a), to that patent application entitled “Optical Transceiver Module” filed in the Korean Intellectual Property Office on Dec. 2, 2005 and assigned Serial No. 2005-117093, the entire contents of which are incorporated herein by reference.

### BACKGROUND OF THE INVENTION

1. Field of the Invention

The present invention relates to an optical transceiver module, and more particularly to an optical transceiver module including an electro-absorption modulator.

2. Description of the Related Art

In general, optical transceiver modules may employ a scheme using an electro-absorption modulator and a laser, an external modulation scheme using a Mach-Zehnder modulator, or a direct modulation scheme capable of performing direct modulation. An optical transceiver module employing the direct modulation scheme can be manufactured in a small size but has a relatively lower dispersion allowance value due to chirping of a light source. In contrast, an optical transceiver module employing an electro-absorption modulator and a laser uses an external modulator causing smaller chirping, Thus, the dispersion allowance value of the optical transceiver module employing the electro-absorption modulator and the laser is higher than that of the optical transceiver module employing the direct modulation scheme. Meanwhile, an optical transceiver module using a Mach-Zehnder modulator has advantages in that chirping is small and its dispersion allowance value is relatively higher.

However, the optical transceiver module using a Mach-Zehnder modulator has a problem in that it is not easy to integrate the optical transceiver module as an single element. Whereas the optical transceiver module employing an electro-absorption modulator can be integrated as a single element and thus can be miniaturized.

In the case of transmitting an optical signal of 10 Gb/s NRZ-OOK (Non Return Zero-On Off Key) through a standard single-mode fiber, the dispersion-limited transmission distance of the optical transceiver module employing the direct modulation scheme is a few kilometer, while the dispersion-limited transmission distance of the optical transceiver module using an electro-absorption modulator is a maximum of 80 km, and the dispersion-limited transmission distance of the optical transceiver module using a Mach-Zehnder modulator is a maximum of 120 km.

In order to transmit an optical signal having an accumulated dispersion state over a dispersion-limited transmission distance, it is necessary to additionally use a separate dispersion compensator or to use an optical transceiver module which employs a modulation scheme providing a high dispersion allowance value, such as a duobinary modulation scheme.

However, since the dispersion compensator is a high-priced device, it is not easy to apply the dispersion compensator to a system having a single channel or a system using a small number of wavelengths because of expense. The duobinary modulation scheme can be realized by using a Mach-Zehnder modulator.

### SUMMARY OF THE INVENTION

Accordingly, the present invention has been made to solve the above-mentioned problems occurring in the prior art, and an object of the present invention is to provide an optical transceiver module capable of increasing the transmission distance of an optical signal without using a expensive dispersion compensator.

To this end, in accordance with one aspect of the present invention, there is provided an optical transceiver module for modulating a binary signal into an optical signal and outputting the optical signal, the optical transceiver module comprising a tap for dividing a binary signal into first and second binary signals, a laser source for frequency-modulating the first binary signal, and an intensity modulator for modulating the second binary signal and a frequency-modulated signal of the laser source into a phase-inverted optical signal.

In accordance with another aspect of the present invention, there is provided an optical transceiver module comprising a laser source for frequency-modulating a first binary signal, and an intensity modulator for modulating a second binary signal and a frequency-modulated signal of the laser source into a phase-inverted optical signal.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of an optical transceiver module according to a first embodiment of the present invention;

FIG. 2 is a block diagram illustrating the construction of an optical transceiver module according to a second embodiment of the present invention; and

FIGS. 3A to 3C are graphs for explaining the operation principle of optical transceiver modules according to the present invention.

### DETAILED DESCRIPTION

Hereinafter, exemplary embodiments of the present invention will be described with reference to the accompanying drawings. For the purposes of clarity and simplicity, a detailed description of known functions and configurations incorporated herein will be omitted as it may obscure the subject matter of the present invention.

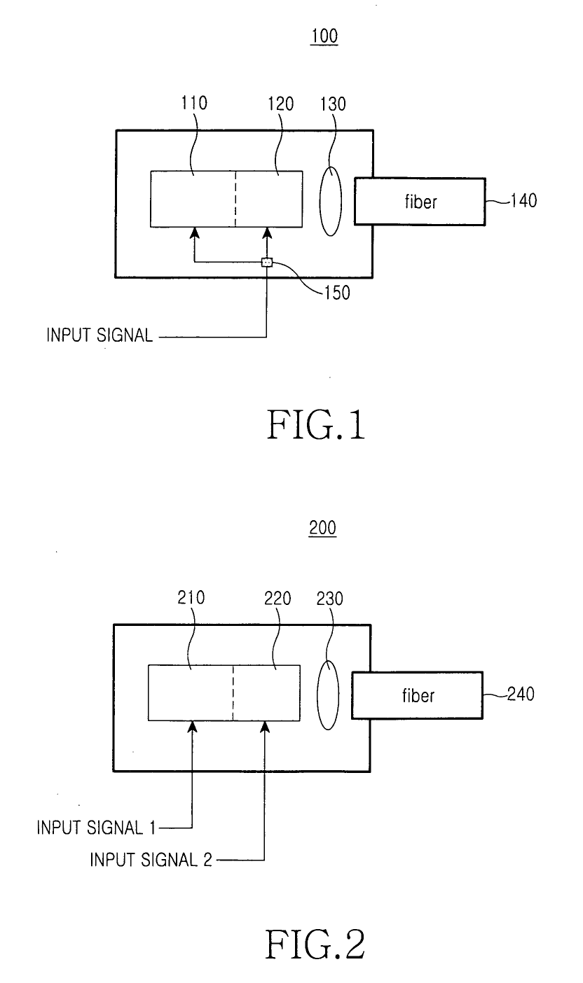

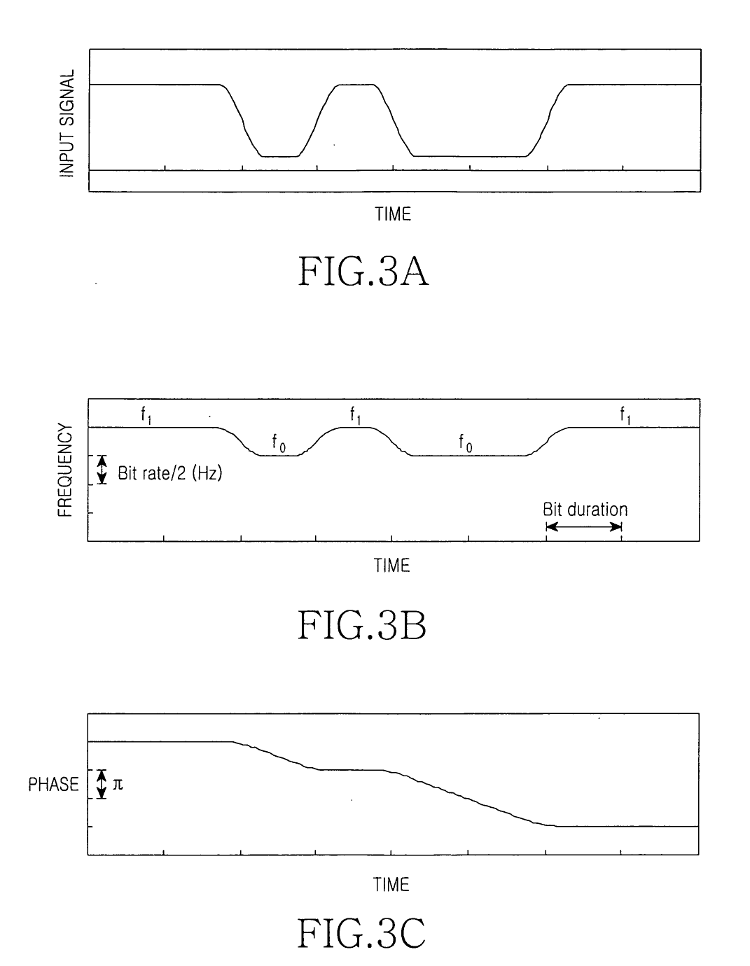

FIG. 1 is a block diagram illustrating the construction of an optical transceiver module according to a first embodiment of the present invention, and FIGS. 3A to 3C are graphs for explaining the operation principle of optical transceiver modules according to the present invention. Referring to FIGS. 1, and 3A to 3C, an optical transceiver module 100 according to the present invention includes a tap 150, a laser source 110, an intensity modulator 120, an optical fiber 140, and a lens system 130. The tap 150 divides a binary signal into two binary signals, and the laser source 110 frequency-modulates one of the two binary signals which had been divided by the tap 150. The intensity modulator 120 modulates the remaining one of the two binary signals which had been divided by the tap 150 and a signal frequency-modulated by the laser source 110, thereby creating an optical signal including phase-inverted data. The lens system 130 transmits the optical signal created by the intensity modulator 120 to the optical fiber 140, and the optical fiber 140 transmits the optical signal to the outside.

The optical transceiver module 100 divides a binary signal to be modulated, which is input from the outside, into two binary signals. The two divided binary signals are applied to the laser source 110 and the intensity modulator 120, respectively. FIG. 3A shows the waveform of a binary signal input to the tap 150, in which the input binary signal is assumed as “11010011”.

When receiving a binary signal as shown in FIG. 3A, the laser source 110 outputs frequency-modulated light as shown in FIG. 3B to the intensity modulator 120. Although the output of the laser source 110 basically required in the present invention is a frequency-modulated light, the laser source 110 may cause intensity modulation as well as frequency modulation if the laser source 110 performs current-modulation. Light created in the laser source 110 is intensity-and-frequency-modulated as a function of the current, as shown in FIG. 3B, and the intensity-and-frequency-modulated light is input into the intensity modulator 120. In FIG. 3B, “f1” represents a frequency when data of a binary signal has a value of “1”, and “f0” represents a frequency when the data of a binary signal has a value of “0”.

The laser source 110 performs the frequency modulation so that “f0” and “f1” may have a relationship as shown in Equation 1, thereby creating and outputting light having a waveform shown in FIG. 3B to the intensity modulator 120.

$$\vert f 1 - f 0 \vert = \frac{B}{2} \qquad ( 1 )$$

In Equation 1, “B” represents a modulation rate (bit rate). When the light modulated to have a relationship as Equation 1 is applied to the intensity modulator 120, the intensity modulator 120 modulates the light created by the laser source 110 into an optical signal phase-inverted at every bit having a value of “zero” based on alternate space inversion.

In order to enable the laser source 110 to modulate a binary signal to a light frequency having a relationship as Equation 1, current based on Equation 2 must be applied to the laser source 110.
ΔI×α=B/2 (2)

In Equation 2, “ΔI” represents the intensity of current applied to the laser source 110, and “α” represents a frequency modulation efficiency of the laser source 110 with respect to the applied current.

The intensity modulator 120 modulates the light provided and modulated by the laser source 110 to an optical signal by means of the other binary divided signals, wherein the intensity of an optical signal modulated by the intensity modulator 120 becomes “zero” when the “f0” has a value of “zero”. That is, an optical signal output from the intensity modulator 120 does not include the component of “f0” intensity-modulated by the laser source 110.

The intensity modulator 120 may include an electro-absorption modulator. Since the intensity modulator 120 performs an intensity modulation operation with respect to an input frequency-modulated optical signal according to an electrical signal input to the intensity modulator 120; the same effect can be obtained even if the intensity modulator 120 is replaced with another type of intensity modulator.

FIG. 3C is a graph showing the phase of an optical signal modulated by the intensity modulator 120. Referring to FIG. 3C, it can be understood that a first “f1” preceding a “f0” and a second “f1” following the “f0” based on the “f0” shown in FIG. 3B have a phase difference of “π”. In addition, it can be understood that a third “f1” preceding two consecutive “f0”s and a fourth “f1” following the two consecutive “f0”s have a phase difference of “2π” (actually, the same phase).

That is, the laser source 110 creates light frequency-modulated to satisfy equation 1, so that an optical signal modulated by the intensity modulator 120 has phases inverted by “π” at every bit having a value of “zero”. The above-mentioned characteristics cause a canceling interference when a signal is dispersed by the chromatic dispersion. For example, when there is a data pattern greatly-influenced by dispersion, such as “101”, the middle bit value “0” prevents the optical signal from being deteriorated by inter-symbol interference, thereby improving the dispersion allowance value to a level corresponding to the high dispersion allowance value of a duobinary signal.

That is, according to the present invention, binary signals having the same data structure are input to the laser source and the intensity modulator, the intensity modulator modulates light frequency-modulated by the laser source to an optical signal which has phases inverted at every bit having a value of “zero”, thereby preventing deterioration of the signal and increasing the dispersion allowance value.

FIG. 2 is a block diagram illustrating the construction of an optical transceiver module according to a second embodiment of the present invention. Referring to FIG. 2, an optical transceiver module 200 according to the present invention includes a laser source 210, an intensity modulator 220, an optical fiber 240, and a lens system 230. The laser source 210 frequency-modulates a first binary signal, and the intensity modulator 220 modulates a second binary signal and a signal frequency-modulated by the laser source 210, thereby creating a phase-inverted optical signal. The intensity modulator 220 can be realized by an electro-absorption modulator, or may be realized with a modulator other than the electro-absorption modulator.

The first and second binary signals have the same data pattern, and the first binary signal is frequency-modulated to satisfy Equation 3.
ΔI×α=B/2 (3)

In Equation 3, “ΔI” represents the intensity of current applied to the laser source 210, and “α” represents the frequency modulation efficiency of the laser source 210 with respect to the applied current. In addition, “B” represents the modulation rate (bit rate) of the laser source 210.

As described above, since the optical transceiver module according to present invention has a higher dispersion allowance value than that of the conventional optical transceiver module, it is possible to create an optical signal having an improved dispersion characteristic, and consequently, it is possible to increase the transmission distance of the optical signal. Therefore, the optical transceiver module of the present invention can transmit an optical signal over a distance even without using a dispersion compensator, and can be used to construct an optical communication system with a low cost.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. An optical transceiver module for modulating a binary signal into an optical signal and outputting the modulated optical signal, the optical transceiver module comprising:
a tap for dividing a binary signal into first and second binary signals;
a laser source for frequency-modulating the first binary signal; and
an intensity modulator for modulating the second binary signal and a frequency-modulated signal of the laser source into a phase-inverted optical signal.

2. The optical transceiver module as claimed in claim 1, wherein the laser source modulates a binary signal applied thereto so as to satisfy:
ΔI×α=B/2
wherein “ΔI” represents an intensity of current applied to the laser source, “α” represents a frequency modulation efficiency of the laser source with respect to the applied current, and “B” represents a modulation rate (bit rate).

3. The optical transceiver module as claimed in claim 1, wherein the intensity modulator comprises an electro-absorption modulator.

4. The optical transceiver module as claimed in claim 1, further comprising:
an optical fiber for transmitting the optical signal; and
a lens system located between the optical fiber and the intensity modulator so as to transmit the optical signal to the optical fiber.

5. An optical transceiver module comprising:
a laser source for frequency-modulating a first binary signal; and
an intensity modulator for modulating a second binary signal and a frequency-modulated signal of the laser source into a phase-inverted optical signal.

6. The optical transceiver module as claimed in claim 5, wherein the first binary signal is modulated so as to satisfy:
ΔI×α=B/2
wherein “ΔI” represents an intensity of current applied to the laser source, “α” represents a frequency modulation efficiency of the laser source with respect to the applied current, and “B” represents a modulation rate (bit rate).

7. The optical transceiver module as claimed in claim 5, further comprising an optical fiber for transmitting the optical signal.

8. The optical transceiver module as claimed in claim 5, wherein the intensity modulator comprises an electro-absorption modulator.

9. A method for modulating a binary signal into an optical signal and outputting the modulated optical signal, the method comprising the steps of:
frequency-modulating a first binary signal and providing the frequency modulated first binary signal to an intensity modulator;
intensity modulating provided frequency modulated first binary signal and a second binary signal which is copy of the first binary signal.

10. The method as claimed in claim 9, wherein the first binary signal is modulated to satisfy:
ΔI×α=B/2
wherein “ΔI” represents an intensity of current applied to the laser source, “α” represents a frequency modulation efficiency of the laser source with respect to the applied current, and “B” represents a modulation rate (bit rate).

11. The method as claimed in claim 9, wherein step of intensity modulating includes an electro-absorption modulator.

12. The method as claimed in claim 9, further comprising the steps of:
focusing the intensity-modulated optical signal; and
transmitting the optical signal over an optical fiber.

13. The method a claimed in claim 9, further comprising the step of:
splitting a binary signal to form the first and second binary signals.
